(19) United States
(12) Patent Application Publication
(10) Pub. No.: US 2006/0161716 A1
(43) Pub. Date: Jul. 20, 2006

(54) Adapter for connecting a portable memory unit to a host, and a memory device having the adapter

(75) Inventor: Feng Hsi Lin, Shulin City (TW)

Correspondence Address: TROXELL LAW OFFICE PLLC, SUITE 1404, 5205 LEESBURG PIKE, FALLS CHURCH, VA, 22041, US

(73) Assignee: Incomm Technologies Co., Ltd.

(21) Appl. No.: 11/332,182

(22) Filed: Jan. 17, 2006

(30) Foreign Application Priority Data
Jan. 18, 2005 (TW) 094101383

(51) Int. Cl. G06F 13/20

(52) U.S. Cl. 710/313

(57) ABSTRACT

An adapter for connecting a portable memory unit to a host, comprises a first connector, a second connector, a third connector and a coupling circuit. The first connector is for connecting the portable memory unit for transmitting power and data signals. The data signals are conforming to a communication protocol which is readable by the host. The second connector is for connecting the host for transmitting the data signals. The third connector is for connecting the host for transmitting electric power. The coupling circuit connects the first and second connectors for transmitting the data signals, in addition, the coupling circuit also connects the first and third connectors for transmitting the electric power.

### BACKGROUND OF INVENTION

1. Field of the Invention

This invention is related to an adapter for connecting a portable memory unit to a host. In particularly, this invention is related to a memory device which includes a portable flash memory unit having SD/SATA interfaces and an adapter having two separate connectors for connecting with the SATA and power receptacles of the host respectively.

2. Description of the Prior Art

Nowadays, a variety of portable memory devices and peripherals are developed and widely used. For example, the portable memory device can be USB Flash Disk, Compact Flash Card (CF card), Memory Stick (MS card), Secure Digital (SD card), Multi-Media Card (MMC), xD Card, Micro Hard Disk which have either CF or USB interface, and a hard disk located at the external portable box which have USB or PCMCIA interface, etc. These portable memory devices enhance the convenience of user.

The conventional portable memory device includes a non-volatile memory array, a memory controller, and an I/O interface. The non-volatile memory array is used for storing the data and preserves the data without an external power supply. Therefore, the non-volatile memory array is usually made by a flash memory. Of course, the designer can replace the hard disk with the non-volatile memory array. The memory controller includes a circuit, a communication interface and a driving mechanism for driving and accessing the non-volatile memory array. The driving mechanism can be implemented by a hardware (command sequencer circuit) which executes corresponding micro-code or by micro-controller/micro-processor which executes corresponding firmware stored in the controller portable memory device. The communication interface of the portable memory device used a corresponding protocol to communicate with an external device.

Please refer to FIG. 1. FIG. 1 illustrates a block diagram of a conventional flash memory card and a computer. The conventional Flash memory card 11 can not directly communicate with the computer 12 because the computer 12 doesn't have the connector and/or the communication protocol for the conventional Flash memory card 11. In order to communicate with the computer 12, the Flash memory card 11 needs to plug in an external card reader 13 which has a USB interface to communicate with the computer 12 via the external card reader 13. The external card reader 13 not only has the first interface connector 131 for the computer 12, such as the USB connector, and the second interface connector 132 for the Flash Memory card 11, but also a format converter circuit 133 (e.g., interface transforming circuit) for converting the first format of data received by the first interface connector 131 into the second format of data accepted by the computer 12, such as the USB format. This would be inconvenient for users and the cost would be higher.

In addition, various kinds of peripheral interfaces such like USB, IEEE-1394 (FIREWIRE), Serial Advanced Technology Attachment (SATA) and etc. are provided by personal computers (PC) or computer notebooks. Among these “host provided” peripheral interfaces, only the USB interface includes a power supply terminal (i.e., the VDD/VBUS voltage signal). Neither the FIREWIRE interface nor the SATA interface provides such power supply terminal. Because the needs for higher speed of data transmission has become a trend of portable memory devices, it can be foreseen that the bandwidth of 480 Mbps of USB 2.0 will be definitely insufficient in the near future. The SATA interface having a bandwidth of 1.5 Gbps might be relatively adequate to our needs for high transmission speed of portable memory devices. However, the lack of power supply terminal will become a problem of the portable memory devices using SATA interface.

It is noted that, improvements of various peripheral interfaces of computers are always keeping developed by manufacturers to satisfy the requirements of high-speed data storage devices. For example, there is now an upgraded version of SATA which is named External SATA (eSATA) available on market. We can also expect that more advanced versions of USB or FIREWARE will come out very soon in the future. All these peripheral interfaces may be applicable to the claiming scope of the present invention.

### SUMMARY OF INVENTION

It is therefore one of the objectives of the claimed invention to provide an adaptor for connecting a portable memory unit to a host. The portable memory unit can access power supply from one interface of a host and transmit data via another interface of the same host by means of the adaptor.

It is another one of the objectives of the claimed invention to provide a memory device that includes a multi-interface auto-switch flash memory card and an adaptor for receiving that flash memory card. The flash memory card has a memory card interface and a host interface. When the memory device is connected to a host, the flash memory card received inside the adaptor will automatically switch to use the host interface for communicating with the host as well as obtain power supply from the host.

It is yet another one of the objectives of the claimed invention to provide a multi-interface auto-switch circuit located at a portable memory unit. At the same moment, only one interface is activated, whereas the other interface is inactive. Since the inactive interface does not consume power, the total power consumption can be reduced.

In order to achieve aforementioned objectives, the present invention discloses an adapter for connecting a portable memory unit to a host. The adaptor comprises a first connector, a second connector, a third connector and a coupling circuit. The first connector is for connecting the portable memory unit for transmitting a power and data signals. The data signals are comply with a communication protocol which is readable by the host. The second connector is for connecting the host for transmitting the data signals. The third connector is for connecting the host for transmitting electric power. The coupling circuit connects the first and second connectors for transmitting the data signals, in addition, the coupling circuit also connects the first and third connectors for transmitting the electric power.

In a preferred embodiment of the present invention, the portable memory unit is furnished with a multi-interface auto-switch circuit and is able to use either a memory card interface or a host interface to communicate with an external device, such like a host or a card reader. The multi-interface auto-switch circuit comprises a power detecting and supplying module and an interface switch circuit. The power detecting and supplying module detects and receives the voltage signal from the external device and generates a corresponding electrical signal. The interface switch circuit, which connects to the power detecting and supplying module, receives the corresponding electrical signal and is controlled to connect either the memory card interface or the host interface with the external device according to the corresponding electrical signal.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

The details of the present invention will be more readily understood from a detailed description of the preferred embodiments taken in conjunction with the following figures.

FIG. 1 is a schematic drawing of a conventional flash memory card and a computer;

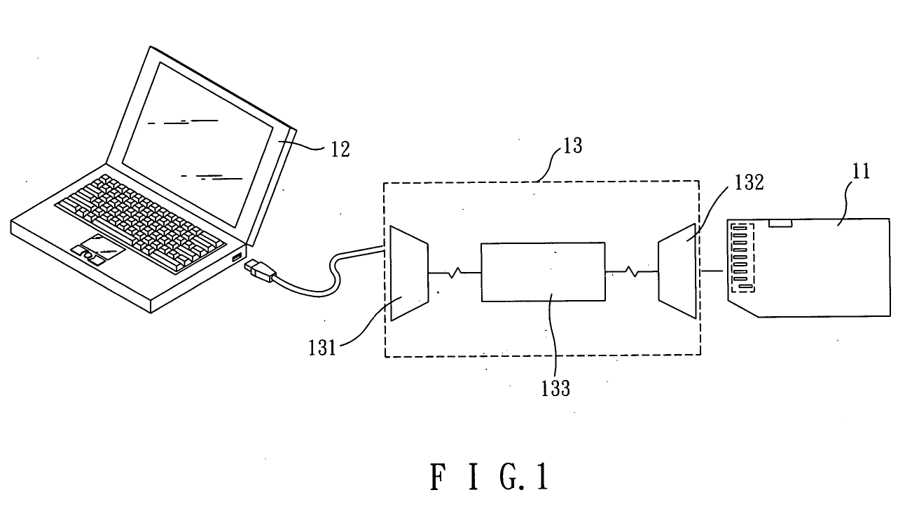

FIG. 2 is a schematic drawing of a first embodiment of the memory device having a portable memory unit and an adaptor which is connectable to a host according to the present invention;

FIG. 3 is a schematic drawing of a first embodiment of the coupling circuit of the adaptor in accordance with the present invention;

FIG. 4 is a block diagram showing a first embodiment of the multi-interface auto-switch circuit of the portable memory unit according to the present invention;

FIG. 5 is a block diagram showing a second embodiment of the multi-interface auto-switch circuit of the portable memory unit according to the present invention;

FIG. 6 is a schematic drawing of a second embodiment of the memory device having a portable memory unit and an adaptor which is connectable to a motherboard of host according to the present invention

FIG. 7 is a schematic drawing of a second embodiment of the coupling circuit of the adaptor in accordance with the present invention; and

FIG. 8 illustrates a flowchart of an embodiment of a multi-interface auto-switch circuit according to the present invention.

### DETAILED DESCRIPTION

The present invention discloses an adapter for connecting a portable memory unit to a host. The portable memory unit is furnished with a multi-interface auto-switch circuit and is able to use either a memory card interface or a host interface to communicate with an external device, such like a host or a card reader. The multi-interface auto-switch circuit comprises a power detecting and supplying module and an interface switch circuit. The power detecting and supplying module detects and receives the voltage signal (VDD/VBUS) from the external device and generates a corresponding electrical signal. The interface switch circuit, which connects to the power detecting and supplying module, receives the corresponding electrical signal and is controlled to connect either the memory card interface or the host interface with the external device according to the corresponding electrical signal.

Because neither the SATA interface nor the FIREWARE interface of host (computer) provides the VDD/VBUS voltage signal, the adaptor of the present invention employs a third connector to connect with a power supply receptacle of the host to obtain the VDD/VBUS voltage signal, in the mean time, the adaptor also employs a second connector to connect with the SATA or FIREWARE interface of host, and a first connector to connect with the portable memory unit. Since the voltage signal obtained from the host is 5.0 Volts which is higher than the ordinary operating voltage 3.3 Volts of most flash memory cards (such as SD, MMC and etc), the power detecting and supplying module of the present invention will be able to determine which interface (either the host interface or the memory card interface) to use by simply comparing the input voltage signal with a predetermined voltage value, for example, 4.2 Volts or any other value between 3.3˜5.0.

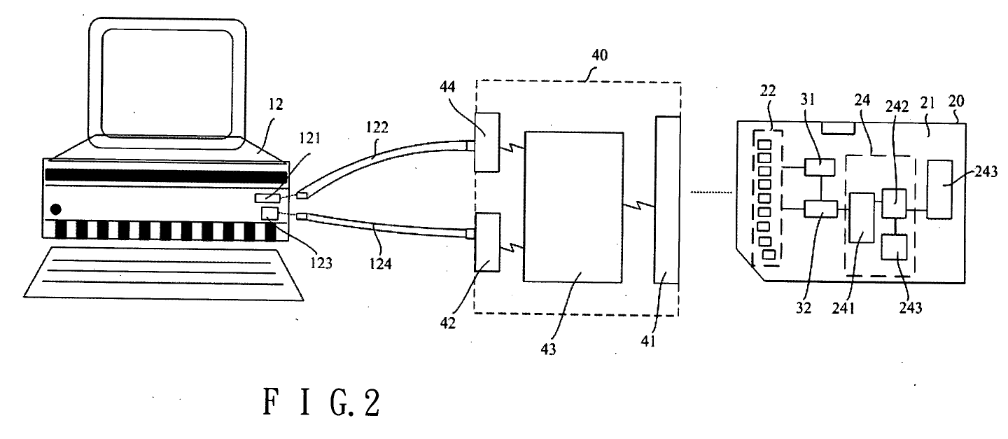

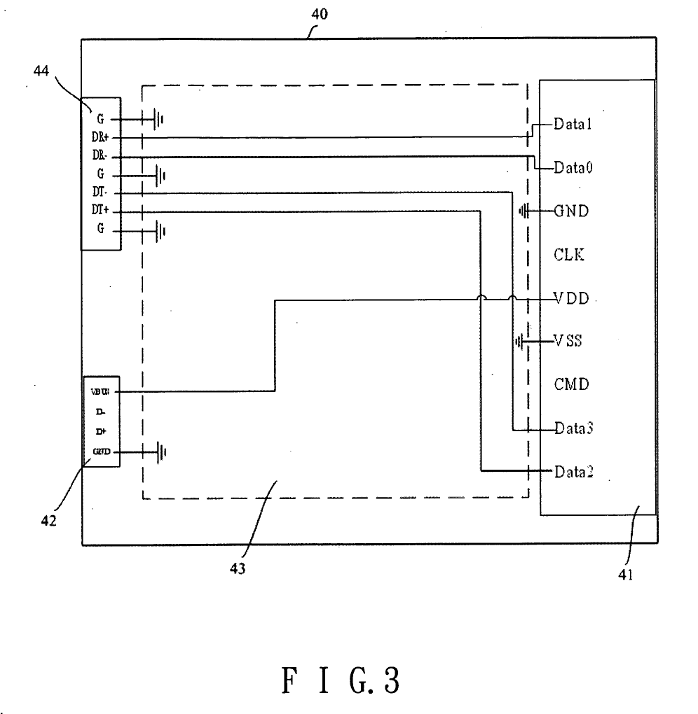

Please refer to FIG. 2 and FIG. 3, wherein FIG. 2 is a schematic drawing of a first embodiment of the memory device having a portable memory unit 20 and an adaptor 40 which is connectable to a host 12 according to the present invention, while FIG. 3 is a schematic drawing of a first embodiment of the coupling circuit 43 of the adaptor 40 in accordance with the present invention.

In the first preferred embodiment shown in FIG. 2 and FIG. 3, the adaptor 40 of the present invention comprises: a card connector 41 (also referred as the first connector hereunder), a USB connector 42 (also referred as the third connector), a SATA connector 44 (also referred as the second connector), and a coupling circuit 43. The SATA connector 44 and the USB connector 42 are respectively connected to the SATA receptacle 121 (also referred as the first receptacle) and the USB receptacle 123 (also referred as the second receptacle) located on the outer casing of the host 12 (e.g., computer) by means of the SATA cable 122 and the USB cable 124. The card connector 41 is connectable in a detachable manner with the portable memory unit 20 which is capable of communication by using either a memory card interface or a host interface. Through the connection of cables 122, 124 between the adaptor 40 and the host 12, the portable memory unit 20 of the present invention will automatically switch to use the host interface so as to transmit data with the host 12.

When the portable memory unit 20 is received and connected to the card connector 41 of the adaptor 40, at least some part of the portable memory unit 20 would be exposed outside the adaptor 40 for allowing the user to pull out or to exchange the card connector 41. In another embodiment, the adaptor 40 can also be furnished with an additional card-ejecting mechanism (not shown in figures) for removing the portable memory unit 20 from the adaptor 40.

Please refer to FIG. 3, the adaptor 40 in accordance with the first embodiment of the present invention comprises: a card connector 41 (also referred as the first connector hereunder), a USB connector 42 (also referred as the third connector), a SATA connector 44 (also referred as the second connector), and a coupling circuit 43 for electrically coupling the connectors 41, 42, 44. Wherein, the coupling circuit 43 couples/connects the plural “data signal terminals” of the SATA connector 44 to the corresponding “data signal terminals” of the card connector 41 for transmitting SATA data signals. In addition, the coupling circuit 43 also couples/connects the “voltage signal terminals (VBUS and GND)” of the USB connector 42 to the corresponding “voltage signal terminals (VDD, VSS and GND)” of the card connector 41 for transmitting voltage signals as well as supplying electric power. Therefore, there is no need to furnish interface transforming circuit inside the adaptor 40. The adaptor 40 of the present invention only need to furnish with a very simple coupling circuit 43 for directly connecting corresponding terminals of these three connectors 41, 42, 44. As a result, the circuit design and manufacture of the adaptor 40 is extremely simple and low cost.

In another embodiment of the present invention, the USB connector 42 of the adaptor 40 can be any kind of connector that is comply with an interface whose operating voltage is different from the ordinary operating voltage 3.3 Volts of flash memory card. Or, the USB connector 42 can also be any kind of power connector that can be connected to a power supply whose output voltage is different from the ordinary operating voltage 3.3 Volts of flash memory card. In addition, the SATA connector 44 can also be exchanged easily by other kinds of interfaces, such like FIREWARE, eSATA, IDE and etc. Moreover, the USB connector 42 and SATA connector 44 of the adaptor 40 can also be integrated into one single connector that can connect to both the power supply connector and SATA connector of the host by using a specially designed cable (e.g., one plug on the adaptor side and two plugs on the host side) for transmitting both voltage signal and data signal.

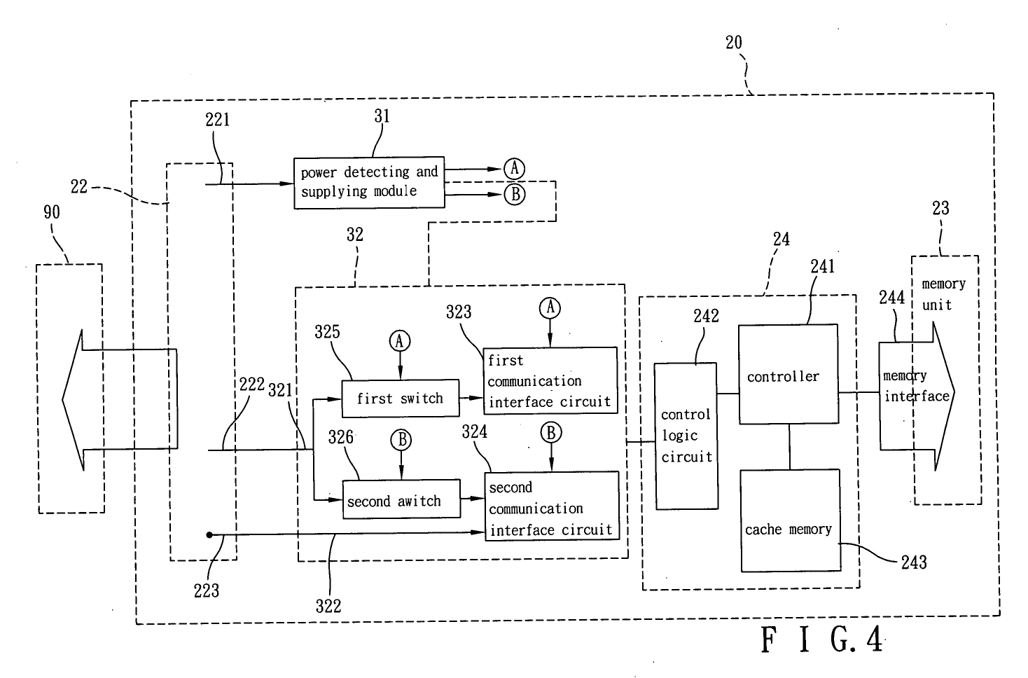

As shown in FIG. 4, the first embodiment of the portable memory unit 20 (e.g., flash memory card) of the present invention comprises a body 21, connection pins 22, a memory unit 23, a control unit 24, and the multi-interface auto-switch circuit of this invention. The multi-interface auto-switch circuit of this invention comprises a power detecting and supplying module 31 and an interface switch circuit 32.

The size of the body 21 fits the size of the flash memory card. In this embodiment, the portable memory unit 20 is a Secure Digital Card (SD). The connection pins 22 are also fit the size of the SD. The portable memory unit 20 of this invention can also be, but not limit to, the Multimedia Card (MMC), Compact Flash (CF), Memory Stick (MS), xD Card, etc.

The connection pins 22 are located on the frontal margin of the body 21 and are exposed externally. Through the connection pins 22, the portable memory unit 20 of this invention can electrically connect to and communicate with an external device 90. The external device 90 can be a card reader, a digital camera, a PDA, a printer, a host (computer) or the adaptor 40 of this invention. The connection pins 22 comprise a supply voltage pin 221 (VBUS/VSS), a plurality of the shared pins 222, and a plurality of the non-shared pins 222. The supply voltage pin 221 (VBUS/VSS) is for receiving the power supply signal. The plurality of the shared pins 222 are for both interfaces. The plurality of the non-shared pins 222 are for only one interface.

The memory unit 23 is implanted in the body 21. The memory unit 23 is composed of a non-volatile memory array for storing data. For example, in the embodiment, the memory unit 23 comprises at least one flash memory. It can also be a read only memory (ROM) or other type of memories.

The control unit 24 is implanted in the body 21 and connected to the memory unit 23. The control unit 24 can drive the memory unit 23, read the data from the memory unit 23, write data into the memory unit 23, and communicate with the external device 90 through the connection pins 22. In this embodiment, the control unit 24 also comprises a controller 241, a control logic circuit 242, a cache memory 243, and a memory interface 244. The controller 241 and the corresponding firmware control the data transporting and processing. The control logic circuit 242 connects between the controller 421 and the interface switch circuit 32. The data from the interface switch circuit 32 is processed by the control logic circuit 242 and, then, is stored in the memory unit 23 through the memory interface 244. The data stored in the memory unit 23 can also be processed by the controller 241 and, then, transported to the pins 22 through the interface switch circuit 32. The cache memory 243 can speed up the data processing.

The power detecting and supplying module 31 connects to the supply voltage pin 221 of connection pins 22. The power detecting and supplying module 31 can receive and detect a voltage comes from the supply voltage pin 221 and generate an electrical signal in corresponding to the received voltage from the supply voltage pin 221. In this embodiment, the power detecting and supplying module 31 can compare the received voltage with a predetermined value and transfer the received voltage signal into either a first power signal A or a second power signal B according to the result of the comparison. The electrical signal mentioned previously is either the first power signal A or the second power signal B.

Generally speaking, the supply voltage of the USB interface is 5.0 voltage, whereas the supply voltage of the memory card such as SD and MMC is 3.3 voltage or lower. This invention sets a value between 3.3 and 5.0 as the predetermined value for the power detecting and supplying module 31. For example, the predetermined value is set as 4.2 or as other value between 3.3 and 5.0. Thus, by comparing the supply voltage comes from the supply voltage pin 221 with the predetermined value, which is 4.2 in this case, whether the external device 90 uses the USB interface (e.g., host interface) or other memory card interface can be detected. In other words, if the supply voltage form the supply voltage pin 221 is greater than the predetermined value, the external device 90 is connected to the USB interface.

The interface switch circuit 32 connects to the power detecting and supplying module 31, and serially connects between the control unit 24 and the connection pins 22. The interface switch circuit 32 can receive the first power signal A and the second power signal B, which are also known as the electrical signal, and switch to connect either the first communication interface or the second communication interface to the control unit 24 and to communicate with the control unit 24 through the connection pins 22. In this embodiment, the first communication interface is the computer interface (also referred as host interface hereinafter), examples of such host interface can be but not limited to be a FIREWARE interface, IDE interface, SATA interface, eSATA interface, USB interface, and etc., whereas the second communication interface is the memory card interface, examples of such memory card interface can be but not limited to be the interface of SD, MMC, CF, MS, xD, and etc.

As shown in FIG. 4, the interface switch circuit 32 also includes a plurality of shared signal line 321, a plurality of non-shared signal line 322, a first communication interface circuit 323 (also referred as host interface circuit) which can be a SATA interface circuit, a second communication interface circuit 324 which is a memory card interface circuit, a first switch 325 and a second switch 326. The plurality of shared signal lines 321 connect to the plurality of the shared pins 222 of the connection pins 22. Both the first communication interface circuit 323 and the second communication interface circuit 324 transfer data through the plurality of the shared lines 321. The plurality of non-shared signal lines 322 connect to the plurality of the non-shared pins 223 of the connection pins 22. Only the second communication interface circuit 324 transfers data through the plurality of the non-shared lines 322. The first communication interface circuit 323 is for processing the data of the first communication interface and converting the data to a first converted signal that can be processed by the control unit 24. The second communication interface circuit 324 is for processing the data of the second communication interface and converting the data to a second converted signal that can be processed by the control unit 24. The plurality of the non-shared lines 322 connect to the second communication interface circuit 324. The first switch 325 connects to the power detecting and supplying module 31 and connects between the plurality of shared lines 321 and the first communication interface circuit 323. The first switch 325 received the first power signal A to determine if the connection between the plurality of the shared lines 321 and the first communication interface circuit 323 should be on. The first switch 325 connects to the power detecting and supplying module 31 and connects between the plurality of shared lines 321 and the first communication interface circuit 323. The second switch 326 connects to the power detecting and supplying module 31 and connects between the plurality of shared lines 321 and the second communication interface circuit 324. The second switch 326 receives the second power signal B to determine if the connection between the plurality of the shared lines 321 and the first communication interface circuit 324 should be on. At any time, the power detecting and supplying module 31 can generate only one of the first power signal A or the second power signal B. In consequence, at any moment, the only one of the first switch 325 or the second switch 326 is turned on. Therefore, at any moment, the portable memory unit 20 of this invention can process and transfer data through only one of the first communication interface circuit 323 or the second communication interface circuit 324. The purpose of auto-switch of the multi-interface can be achieved.

In this embodiment, the first power signal A also supplies the power to the first communication interface circuit 323. The second power signal B also supplies the power to the second communication interface circuit 324. Therefore, at any moment, only one of the first communication interface circuit 323 or the second communication interface circuit 324 is supplied the power and is driven. At this moment, the other communication interface circuit is grounded. In other words, the power detecting and supplying module 31 not only provides the control signal to control the operation of the first switch 325 and the second switch 326, but also provides the power to drive only one of the first communication interface circuit 323 and the second communication interface circuit 324. The communication interface circuit which is not driven is grounded. Thus, the power consumption of the portable memory unit 20 can be reduced.

As shown in FIG. 4, because both the body 21 and the connection pins 22 of the portable memory unit 20 of this invention fit the specification of the memory card interface, the portable memory unit 20 can directly communicate with the external device 90 which has the memory card interface, for example, a digital camera, a cellular phone, a PDA, etc. To connect the portable memory unit 20 to the computer (host) 12, the flash memory card adapter 40 as shown in FIG. 2 and FIG. 3 is needed.

In the following embodiments, most of the components and steps are the same as or similar to the embodiments described previously. Therefore, the same or similar components or steps will be named the same and the detail descriptions will not be repeated.

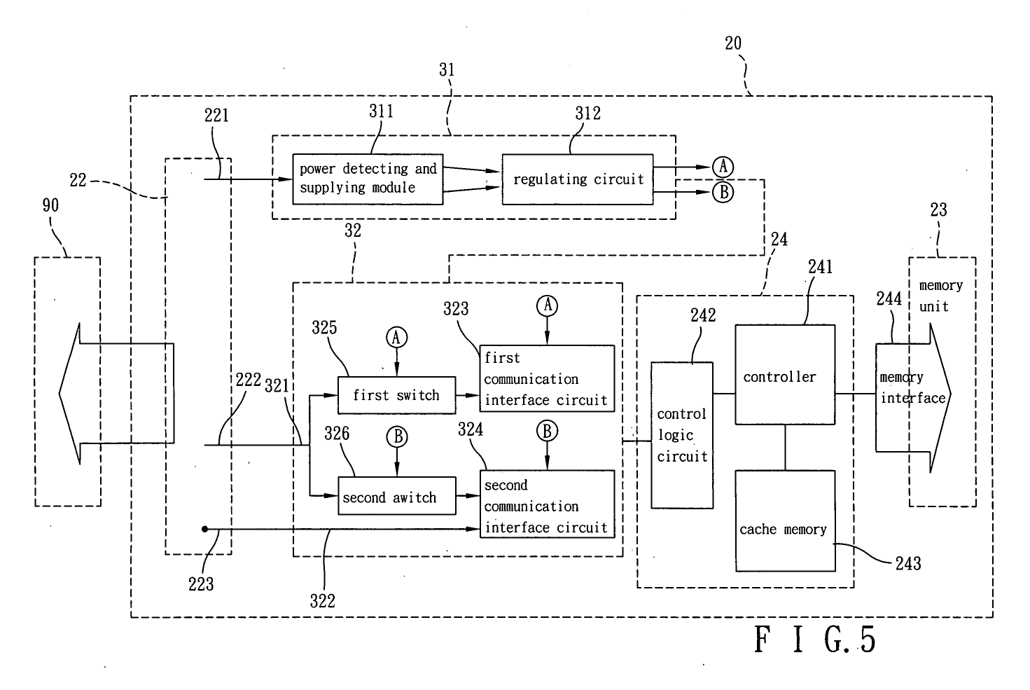

FIG. 5 illustrates a block diagram of a second embodiment of a multi-interface auto-switch circuit according to the present invention. The portable memory unit 20 in FIG. 5 also comprises a body 21, a plurality of connection pins 22, a memory unit 23, a control unit 24, and the multi-interface auto-switch circuit of this invention. The multi-interface auto-switch circuit comprises a power detecting and supplying module 31 and interface switch circuit 32. The embodiment in FIG. 5 is different from the previous embodiment due to that the power detecting and supplying module 31 in FIG. 5 comprises a power detecting circuit 311 and a regulating circuit 312. The power detecting circuit 311 can compare the received voltage with a predetermined value and transform the received voltage into either the first power signal A or the second power signal B according to the result of comparison. Through the regulating circuit 312, the voltage supplied to the interface switch circuit 32 is stable and the first power signal A and the second power signal B can be different from the input voltage of the external device 90.

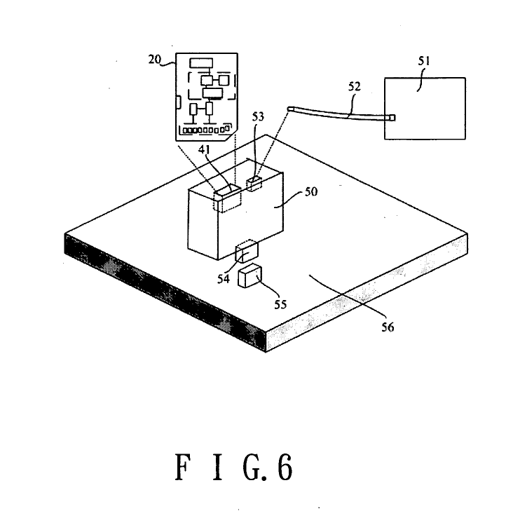

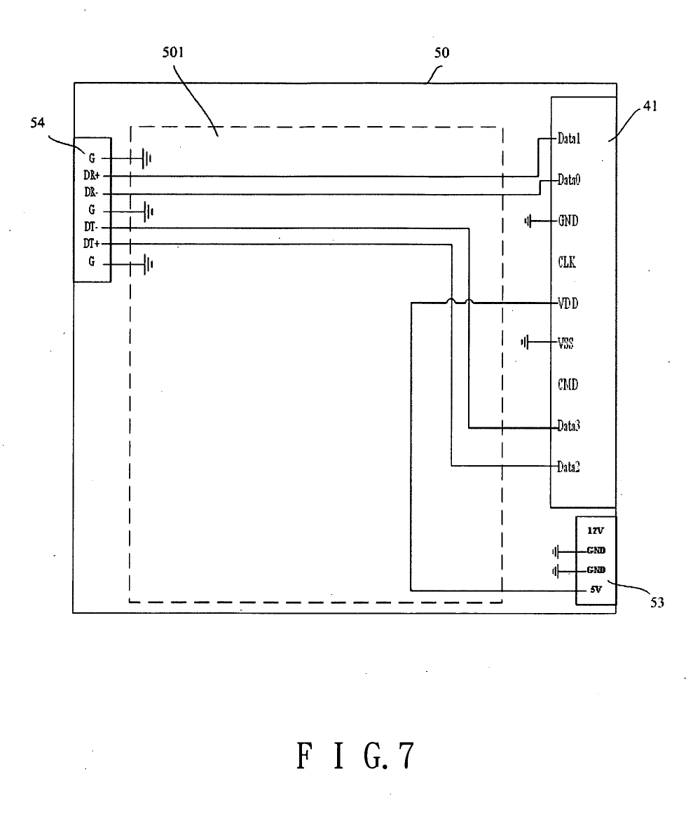

Please refer to FIG. 6 and FIG. 7, wherein FIG. 6 is a schematic drawing of a second embodiment of the memory device having a portable memory unit 20 and an adaptor 50 which is connectable to a motherboard 56 of host according to the present invention, while FIG. 7 is a schematic drawing of a second embodiment of the coupling circuit 501 of the adaptor 50 in accordance with the present invention.

In the second preferred embodiment shown in FIG. 6 and FIG. 7, the adaptor 50 of the present invention comprises: a card connector 41 (the first connector), a power connector 53 (the third connector), a SATA connector 54 (the second connector), and a coupling circuit 501. The SATA connector 54 can be plugged directly into the SATA receptacle 55 (also referred as the first receptacle) furnished on the motherboard 56 of the host. The power connector 53 is a standard 4-pin d-type power socket which can be connected by a standard 4-pin power cable 52 extending from the internal power supply 51 of the host. Wherein, the coupling circuit 501 couples/connects the “data signal terminals” of the SATA connector 54 to the corresponding “data signal terminals” of the card connector 41 for transmitting SATA data signals. In addition, the coupling circuit 501 also couples/connects the “voltage signal terminals (VBUS and GND)” of the power connector 53 to the corresponding “voltage signal terminals (VDD, VSS and GND)” of the card connector 41 for transmitting voltage signals as well as supplying electric power. Therefore, there is no need to furnish interface transforming circuit inside the adaptor 50. The adaptor 50 of the present invention only need to furnish with a very simple coupling circuit 501 for directly connecting corresponding terminals of these three connectors 41, 53, 54. As a result, the circuit design and manufacture of the adaptor 50 is extremely simple and low cost. Moreover, because the portable memory unit 20 of the present invention is furnished with flash memories which have the advantages of solid and strong structure, low power consumption, small size, and low cost, therefore, the assembly of portable memory unit 20 and adaptor 50 of the present invention can be used as a Sold-State Disk (SSD) to replace the internal hard disk or other kinds of magnetic storage devices built in the host computer. Such that, the computer having the assembly of portable memory unit 20 and adaptor 50 built inside will become more compact in size (since the size of portable memory unit 20 and adaptor 50 is much smaller than the hard disk) and more reliable (since the service life of flash memories is much longer than the hard disk) in comparison with conventional computer using hoard disk as its mass data storage. Furthermore, the portable memory unit 20 of the present invention can be easily pulled out from the adaptor 50 and then be replaced by another new portable memory unit 20 with higher capacity of data storage so as to upgrade the storage space of the computer (host).

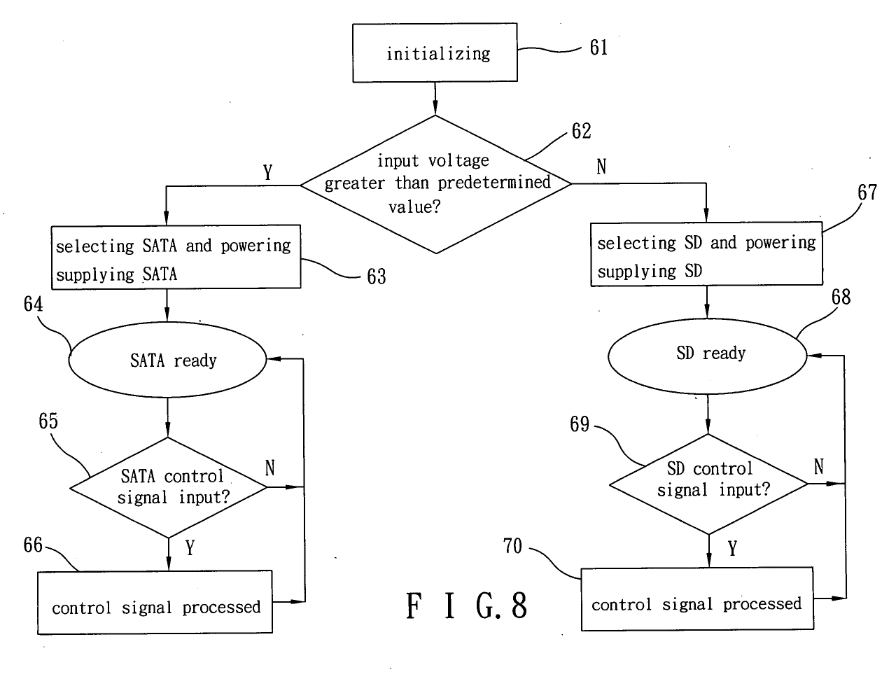

FIG. 8 shows a flowchart of an embodiment of the switching method of the multi-interface auto-switch circuit of this invention. The method of the present invention includes the steps of:

Step 61 is the initializing step. In this step, the portable memory unit 20 of the invention which contains the multi-interface auto-switch circuit is connecting with, or plugging in, an external device 90 and receiving an input voltage (VBUS/VDD) from the external device 90.

In step 62, the received input voltage is checked to determine if it is greater than a predetermined value. If it is greater than the predetermined value, the step 63 is then executed. If it is not greater than the predetermined value, the step 67 is then executed.

In step 63, the SATA bus is selected and the power is supplied to the SATA bus. In other words, the first switch 325 is turned on and power is supplied to the first communication interface circuit 323.

In step 64, the SATA bus is ready.

In step 65, it is checking if there is any SATA control signal inputted. If it is, the step 66 is then executed. If it is not, the step 64 is then executed.

In step 66, the SATA control signal is processed and the operation the portable memory unit 20 of the invention responds to the SATA control signal.

In step 67, the SD bus is selected and the power is supplied to the SD interface. In other words, the second switch 326 is turned on and power is supplied to the second communication interface circuit 324.

In step 68, the SD bus is ready.

In step 69, it is checking if there is any SD control signal inputted. If it is, the step 70 is then executed. If it is not, the step 68 is then executed.

In step 71, the SD control signal is processed and the operation the portable memory unit 20 of the invention responds to the SD control signal.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. An adaptor for connecting a portable memory unit to a host, comprises:
a first connector for connecting the portable memory unit for transmitting a voltage signal and a data signal, said data signal complying with a protocol readable by the host;
a second connector for connecting the host for transmitting said data signal;
a third connector for connecting the host for transmitting said voltage signal; and
a coupling circuit, coupling the first connector with the second connector for transmitting said data signal, and also coupling the first connector with the third connector for transmitting said voltage signal.

2. The adaptor of claim 1, wherein the voltage signal is supplied by the host.

3. The adaptor of claim 2, wherein the third connector complies with a standard of USB interface, and the voltage signal is supplied by a USB interface of the host.

4. The adaptor of claim 2, wherein the third connector conforms to a standard 4-pin d-type power socket which can be connected by a standard 4-pin power cable extending from an internal power supply of the host.

5. The adaptor of claim 1, wherein the second connector complies with a standard of data transmitting interface which is supplied by a motherboard of the host.

6. The adaptor of claim 5, wherein said data transmitting interface can be chosen from one of the following: FIREWARE, IDE, SATA and eSATA.

7. The adaptor of claim 1, wherein the portable memory unit is a flash memory card which can be connected to the first connector in a detachable manner.

8. The adaptor of claim 7, wherein the portable memory unit is furnished with a multi-interface auto-switch circuit and is capable of using at least a memory card interface and a host interface to communicate with an external device, in addition, there is no interface transforming circuit furnished in the adaptor.

9. The adaptor of claim 8, wherein the multi-interface auto-switch circuit comprises:
a power detecting and supplying module for receiving and detecting a power voltage of the external device, and producing a voltage signal according to the power voltage of the external device; and
an interface switch module, coupled to the power detecting and supplying module, for receiving the voltage signal from the power detecting and supplying module, and controlling the connection between the external device and one of the memory card interface and the host interface according to the voltage signal.

10. The adaptor of claim 9, wherein the memory card interface can be chosen from one of the following: CF, MS, SD, MMC and xD; in addition, the host interface can be chosen from one of the following: FIREWARE, IDE, SATA and eSATA.

11. The adaptor of claim 1, wherein,
the adaptor is an external adaptor exposed outside the host;
the host further comprises: an outer casing, a motherboard built inside the outer casing, a first receptacle and a second receptacle, the first and second receptacles are exposed outside the outer casing and are electrically connected with the motherboard;
the second connector of the adaptor can be connected to the first receptacle for transmitting data signal with the motherboard; and,
the third connector of the adaptor can be connected to the second receptacle for accessing voltage signal from the motherboard.

12. The adaptor of claim 11, wherein the first receptacle is a receptacle of SATA interface, while the second receptacle is a receptacle of USB interface.

13. The adaptor of claim 1, wherein,
the adaptor is an internal adaptor located inside the host;
the host further comprises a motherboard and a power supply built inside the host, the motherboard being furnished with at least a first receptacle;
the second connector of the adaptor can be connected to the first receptacle for transmitting data signal with the motherboard; and,
the third connector of the adaptor can be connected to the power supply for accessing voltage signal from the power supply.

14. The adaptor of claim 13, wherein the assembly of the portable memory unit and the adaptor can be used as a Sold-State Disk (SSD) located inside the host.

15. An adaptor, comprising:
a first connector, said first connector being capable of connecting a portable memory unit in a detachable manner, the first connector further comprising at least one data signal terminal and at least one voltage signal terminal;
a second connector, said second connector further comprising at least one data signal terminal but having no voltage signal terminal;
a third connector, said third connector further comprising at least one voltage signal terminal; and
a coupling circuit, coupling the data signal terminal of the first connector with the data signal terminal of the second connector for transmitting data signals, and also coupling the voltage signal terminal of the first connector with the voltage signal terminal of the third connector for transmitting voltage signals.

16. The adaptor of claim 15, wherein there is no interface transforming circuit furnished in the adaptor, in addition, the data signals are conforming to a host interface chosen from one of the following: FIREWARE, IDE, SATA and eSATA.

17. A memory device, comprising:
a portable memory unit; and
an adaptor, said portable memory unit being connected to the adaptor in a removable manner, said adaptor further comprising:
a first connector for connecting with the portable memory unit in a detachable manner, the first connector further comprising at least one data signal terminal and at least one voltage signal terminal;
a second connector, said second connector further comprising at least one data signal terminal but having no voltage signal terminal;
a third connector, said third connector further comprising at least one voltage signal terminal; and
a coupling circuit, coupling the data signal terminal of the first connector with the data signal terminal of the second connector for transmitting data signals, and also coupling the voltage signal terminal of the first connector with the voltage signal terminal of the third connector for transmitting voltage signals.

18. The memory device of claim 17, wherein the portable memory unit is furnished with a multi-interface auto-switch circuit and is capable of using at least a memory card interface and a host interface to communicate with an external device;
wherein the multi-interface auto-switch circuit comprises:
a power detecting and supplying module for receiving and detecting a power voltage of the external device, and producing a voltage signal according to the power voltage of the external device; and
an interface switch module, coupled to the power detecting and supplying module, for receiving the voltage signal from the power detecting and supplying module, and controlling the connection between the external device and one of the memory card interface and the host interface according to the voltage signal.

19. The memory device of claim 18, wherein the memory card interface can be chosen from one of the following: CF, MS, SD, MMC and xD; in addition, the host interface can be chosen from one of the following: FIREWARE, IDE, SATA and eSATA.

20. The memory device of claim 19, wherein the external device is a host, and the memory device can be used as a Sold-State Disk (SSD) located inside the host.
